(19) United States
(12) Patent Application Publication
(10) Pub. No.: US 2022/0412130 A1
(43) Pub. Date: Dec. 29, 2022

(54) MOTOR VEHICLE DOOR LOCK ARRANGEMENT FOR A SLIDING DOOR OF A MOTOR VEHICLE

(71) Applicant: Pressan Madeni Esya San. Tic. A.S., Istanbul (TR)

(72) Inventors: Buelent Bilgincan, Istanbul (TR); Izzet Durugoenuel, Istanbul (TR)

(21) Appl. No.: 17/778,650

(22) PCT Filed: Oct. 30, 2020
(86) PCT No.: PCT/EP2020/080550

§ 371 Date: May 20, 2022

(30) Foreign Application Priority Data
Nov. 22, 2019 (DE) 10 2019 131 684.7

(51) Int. Cl. E05B 77/22; E05B 85/12; E05B 83/40; E05B 79/20

(52) U.S. Cl. CPC E05B 77/22; E05B 85/12; E05B 83/40; E05B 79/20; E05B 77/36

(57) ABSTRACT

A motor vehicle door lock arrangement comprising a door handle module with a door handle, wherein the door handle can be actuated by a first actuation, wherein door locks each comprise an actuation element, whereby the first actuation is transmitted to the actuation elements, wherein the first actuation comprises a first actuation stroke. It is proposed that the first actuation stroke is divided into a first and a second stroke section, the first stroke section being followed by the second stroke section, and that during the first actuation stroke of the door handle the actuation elements are actuated during the first stroke section of the first actuation stroke and are not actuated during the second stroke section of the first actuation stroke.

### CROSS-REFERENCE TO RELATED APPLICATIONS

This application is a national stage application under 35 U.S.C. 371 of International Patent Application Serial No. PCT/EP2020/080550, entitled “Motor Vehicle Door Lock Arrangement for a Sliding Door of a Motor Vehicle,” filed Oct. 30, 2020, which claims priority from German Patent Application No. DE 10 2019 131 684.7, filed Nov. 22, 2019, the disclosure of which is incorporated herein by reference.

### FIELD OF THE TECHNOLOGY

Various embodiments relate a motor vehicle door lock arrangement for a sliding door of a motor vehicle and to a door handle module for a sliding door.

### BACKGROUND

Conventionally, sliding doors of motor vehicles have an inner and an outer door handle. These door handles can be connected mechanically via an actuation drive train to one or more door locks. Usually sliding doors comprise at least a first door lock which is a primary lock in the rear part of the sliding door used for keeping the door closed in a closed state of the door and a second door lock which is a holding lock used for holding the door in at least a fully open state of the door. Some sliding doors comprise a third door lock also used for keeping the door closed in a closed state of the door.

If the user actuates one of the door handles, one or more of the door locks are unlatched. This unlatching typically occurs by actuation of all elements of the actuation drive train between the handle and the respective door lock. However, typically the user does not stop actuating the door lock until the opening or closing of the sliding door is complete. This means that for example if the user opens the sliding door at the end of the opening moving of the sliding door the holding lock for holding the sliding door in the open position might still be actuated. In this case, it can happen that when the user releases the door handle the holding lock is not securely latched and the sliding door starts sliding into the closing direction. The same can occur with the main lock during the closing of the sliding door.

Different solutions for this problem are known in the prior art. For example, many inner door handles can be actuated in a first actuating direction and in a second actuating direction, each actuating direction corresponding to either the opening or the closing movement of the sliding door and only unlatching the respective door lock thereby allowing the sliding door to fall shut into the other door lock. This solution, however, has the problem that the actuation drive train needs to comprise different actuation mechanisms for the different door locks.

### SUMMARY

It is therefore the object of the present disclosure to provide a motor vehicle door lock arrangement for a sliding door with a simplified mechanical structure.

The above-noted problem is solved for a motor vehicle door lock arrangement with the features described herein.

It is generally presumed here that the door handle can be user-actuated by a first actuation in a first actuating direction, that the at least two door locks each comprise an actuation element and can each be unlatched by the actuation of the door handle in the first actuating direction whereby the first actuation is mechanically transmitted through the actuation drive train to each of the actuation elements and that the first actuation comprises a first actuation stroke in the first actuating direction from a neutral position to a first end position of the door handle.

The realization for the disclosure is that even if the door handle remains user-actuated during the whole movement of the sliding door, it is possible to actuate the door locks only during a first part of the actuation of the door handle.

In detail, it is proposed that the first actuation stroke of the door handle is divided into a first and a second stroke section, the first stroke section being followed by the second stroke section, and that during the first actuation stroke of the door handle the actuation elements of the door locks are actuated during the first stroke section of the first actuation stroke and are not actuated during the second stroke section of the first actuation stroke.

In various embodiments, the door handle can be user-actuated by a second actuation also unlatching the at least two door locks. It is then possible to actuate the door locks with a simple mechanism in either direction without compromising the easy handling of the sliding door.

In various embodiments the actuation drive train comprises a coupling element which is deflected from a neutral position thereby actuating the at least two door locks in the first stroke section and which is returned at least partially to the neutral position thereby not actuating the at least two door locks any more during the second stroke section.

The mechanism for dividing the first and, in some embodiments, also the second actuation stroke is provided in some embodiments. According to various embodiments, the actuation drive train may comprise a handle section comprising a main lever. This main lever can, in particular, be the coupling element. According to various embodiments, the main lever can be pivoted during the first stroke section from a neutral position to an end position while returning to the neutral position during the second section of the actuation stroke. It can be that the second actuation stroke has the same effect as the first actuation stroke. Therefore all description of the first actuation stroke can be applied to the second actuation stroke and vice versa.

In some embodiments, the only or main difference between the first and the second actuation of the door handle is that the actuations may be transmitted through the handle section along different actuation paths, such as the different actuation paths both start at different parts of the main lever. This embodiment enables having two actuating directions with only a few mechanical elements.

Various embodiments concern an engaging element for engaging the coupling element. The embodiment of the combination of the coupling element and the engaging element in the handle section is described herein.

While various embodiments of the coupling element can be easily produced, during use they may generate unwanted noise. Therefore in various embodiments, the coupling element engages a primary damping element when reaching the neutral position and/or the end position. According to various embodiments, a dampening of the coupling element is provided by a hydraulic and/or pneumatic dampening element.

According to various embodiments the actuation drive train may consist of a single connecting element in at least a first connecting section further reducing the number of necessary mechanical parts. The actuation drive train may comprise a second connecting section according to various embodiments where the actuation drive train is split into at least two connecting elements by an adapter module of the second connecting section of the actuation drive train, in particular for connecting the actuation drive train to the actuation elements.

According to various embodiments, a door handle module may comprise an inner door handle and an outer door handle. Those door handles may be actuated in different actuating directions which in various embodiments may all be conducted through the coupling element in the same manner.

Various embodiments are directed to a door handle module for a sliding door as described above. The door handle module comprises a door handle and the coupling element. All explanations given with respect to the door handle module of the first teaching are fully applicable to the second teaching.

Various embodiments provide mounting of the door handle module on the sliding door.

Various embodiments provide a motor vehicle door lock arrangement for a sliding door of a motor vehicle, in particular a car, comprising a door handle module with a door handle, at least a first door lock, in particular a primary lock, a second door lock, in particular a holding lock, and a mechanical actuation drive train, wherein the door handle is connected to the first and the second door lock via the actuation drive train, wherein the door handle can be user-actuated by a first actuation in a first actuating direction, wherein the at least two door locks each comprise an actuation element and can each be unlatched by the actuation of the door handle in the first actuating direction, whereby the first actuation is mechanically transmitted through the actuation drive train to each of the actuation elements, wherein the first actuation comprises a first actuation stroke in the first actuating direction from a neutral position to a first end position of the door handle, wherein the first actuation stroke of the door handle is divided into a first and a second stroke section, the first stroke section being followed by the second stroke section, and that during the first actuation stroke of the door handle the actuation elements of the door locks are actuated during the first stroke section of the first actuation stroke and are not actuated during the second stroke section of the first actuation stroke.

In various embodiments, the door handle can be user-actuated by a second actuation in a second actuating direction, which can be opposite to the first actuating direction, that the at least two door locks can each be unlatched by the second actuation of the door handle in the second actuating direction, whereby the second actuation is mechanically transmitted through the actuation drive train to each of the actuation elements, that the second actuation comprises a second actuation stroke in the second actuating direction from a neutral position to a second end position of the door handle, that the second actuation stroke of the door handle is divided into a first and a second stroke section, the first stroke section being followed by the second stroke section, and that during the second actuation stroke of the door handle the actuation elements of the door locks are actuated during the first stroke section of the second actuation stroke and are not actuated during the second stroke section of the second actuation stroke.

In various embodiments, the actuation drive train comprises a coupling element, that during the first stroke section of the first, and in some embodiments also the second, actuation stroke the coupling element is deflected from a neutral position thereby actuating the at least two door locks, and that during the second stroke section of the first, and in some embodiments also the second, actuation stroke the coupling element is returned at least partially to the neutral position thereby not actuating the at least two door locks anymore. In some embodiments, that during the first stroke section of the first, and in some embodiments also the second, actuation stroke a rear section of the actuation drive train located between the at least two door locks and the coupling element is coupled to a front section of the actuation drive train located between the coupling element and the door handle and that in the second stroke section of the first, and in some embodiments also the second, actuation stroke the front section is decoupled from the rear section.

In various embodiments, the actuation drive train comprises a handle section being part of the door handle module, that the handle section comprises a main lever with a pivot axis, in particular that the main lever is the coupling element, that during the first stroke section of the first actuation stroke the main lever is pivoted around its axis into an actuating direction of the main lever and that during the second stroke section of the first actuation stroke the main lever is pivoted around its axis against the actuating direction, such that during the first stroke section of the second actuation stroke the main lever can be pivoted around its axis into the actuating direction of the main lever and that during the second stroke section of the second actuation stroke the main lever is pivoted around its axis against the actuating direction of the main lever.

In various embodiments, during the first stroke section of the first, and in some embodiments also the second, actuation stroke the main lever is pivoted from a neutral position to an end position and that during the second stroke section of the first, and in some embodiments also the second, actuation stroke the main lever is returned from the end position to the neutral position.

In various embodiments, the first and the second actuation of the door handle are transmitted through the handle section along different actuation paths, such as that the different actuation paths both start at different parts of the main lever, or such as that the main lever has a first and a second lever arm extending in opposite directions from the pivot axis and that the door handle acts on the first lever arm during the first actuation, in particular the first stroke section of the first actuation stroke, and on the second lever arm during the second actuation, in particular the first stroke section of the second actuation stroke.

In various embodiments, the actuation drive train comprises an engaging element that directly engages the coupling element during the first stroke section of the first actuation stroke and/or the second actuation stroke, that the engaging element moves from a neutral position to an overtravel position during the first stroke section of the first actuation stroke and/or the second actuation stroke and that the engaging element passes by the coupling element, disengaging the coupling element during the second stroke section of the first actuation stroke and/or the second actuation stroke, such as that the engaging element engages and/or passes by the coupling element during a release of the door handle from the first and/or second actuation without actuating the at least two door locks, returning through the overtravel position to the neutral position.

In various embodiments, the main lever comprises at least one secondary lever, or one secondary lever on each main lever arm, mounted pivotally on the main lever, such as that during the first and/or second actuation stroke, in particular during the first stroke section of the first and/or second actuation stroke, the secondary lever is deflected in a first direction of the secondary lever and deflects the main lever and that during the second stroke section of the first and/or second actuation stroke the secondary lever is deflected in a direction opposite to the first direction of the secondary lever without deflecting the main lever.

In various embodiments, the door handle is connected, in particular directly, to a first and a second pin which pins each constitute an engaging element, each pin engaging an associated secondary lever during the first stroke section of the respective actuation stroke in the first direction of the secondary lever and in some embodiments disengaging the secondary lever during the second stroke section of the respective actuation stroke.

In various embodiments, the coupling element is dampened at least partially in movement during deflection from the neutral position and/or during returning to the neutral position, such as that the coupling element engages a primary dampening element when reaching its neutral position and/or an end position of the coupling element, such as that the pivoting of the secondary lever or levers is dampened by a secondary dampening element.

In various embodiments, the coupling element is dampened by a hydraulic and/or pneumatic dampening element, such as that the hydraulic and/or pneumatic dampening element is arranged on the pivot axis of the main lever.

In various embodiments, the actuation drive train comprises a first connecting section where the actuation drive train consists of a single connecting element, in particular a Bowden cable, such as that the first and the second actuation are transmitted in the same direction through the connecting element of the first connecting section, such as that the connecting element is connected directly to the coupling element, in particular the main lever, or the engaging element.

In various embodiments, the actuation drive train comprises a second connecting section where the actuation drive train is split into at least two connecting elements, in particular Bowden cables, by an adapter module of the second connection section of the actuation drive train, such as that each of the connecting elements of the second connecting section is directly connected to an actuation element.

In various embodiments, the door handle module comprises an inner door handle and an outer door handle, that the inner door handle can be actuated in a first and a second actuating direction and the outer door handle can be actuated only in a first actuating direction, such as that both door handles are connected to the adapter module and that the coupling element is part of the adapter module, such as that each actuation is conducted through the coupling element in the same manner.

In various embodiments, the door handle module comprises a door handle and that the door handle module comprises the coupling element.

In various embodiments, the door handle module can be mounted on the sliding door such that the first actuating direction is, at least mostly, directed towards an opening direction of the sliding door and that the second actuating direction is, at least mostly, directed towards a closing direction of the sliding door and, in some embodiments, that the first door lock is a front lock and the second door lock is a rear lock.

### BRIEF DESCRIPTION OF THE DRAWINGS

In the following, an embodiment is explained with respect to the drawings. In the drawings show

FIG. 1 a motor vehicle with a proposed motor vehicle door lock arrangement,

FIG. 2 the door handle module and a part of the actuation drive train of the proposed motor vehicle door lock arrangement in a) and c) a non-actuated position and in b) and d) at the end of the second stroke section,

FIG. 3 the door handle module and a part of the actuation drive train in a) and c) at the end of the first stroke section and b) and d) at the beginning of the second stroke section,

FIG. 4 the door handle module and a part of the actuation drive train in a) and c) during the release of the door handle and in b) and d) later during the release of the door handle,

FIG. 5 the door handle module and a part of the actuation drive train in two different views, and

FIG. 6a) the door handle module and a part of the actuation drive train in a perspective and sectional view and b) part of the door handle module in an exploded view.

### DETAILED DESCRIPTION

The proposed motor vehicle door lock arrangement 1 may be used for a sliding door 2 of a motor vehicle 3. The motor vehicle 3 is here a car. The motor vehicle door lock arrangement 1 comprises a door handle module 4 with a door handle 5, at least a first door lock 6 and a second door lock 7.

Here the motor vehicle door lock arrangement 1 is assigned to a sliding door 2. However, the motor vehicle door lock arrangement 1 may also be assigned to another door like a side door, a wing door, a back door, a trunk lid or any other door of a motor vehicle 3, as long as the door comprises at least two door locks 6, 7. All explanations made with reference to the sliding door 2 may also concern any other type of door.

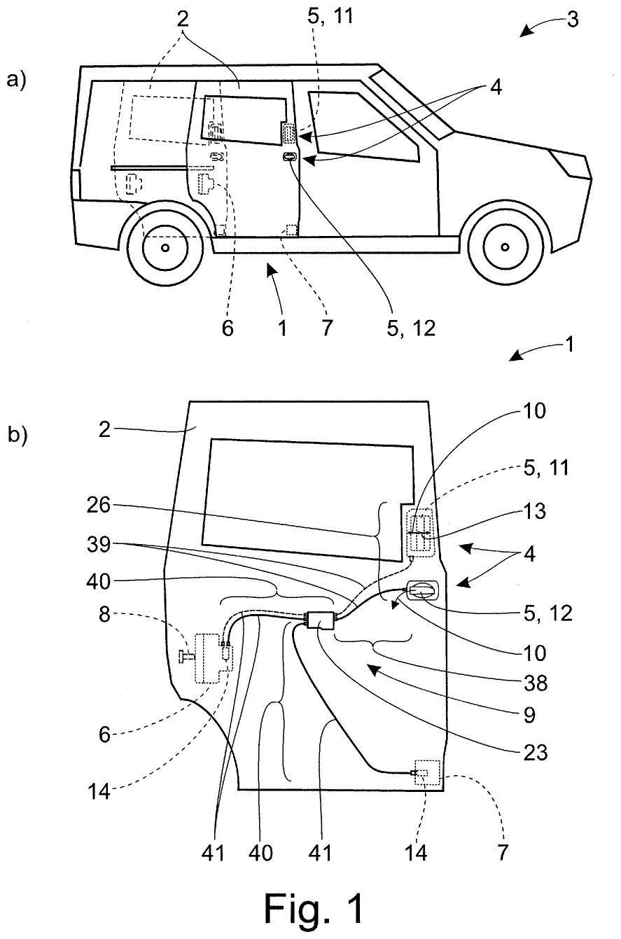

The first door lock 6 is here a primary lock of the sliding door 2. As described in the introductory part of the specification this primary lock serves to hold the sliding door 2 closed in a closed position of the sliding door 2 as shown in FIG. 1a). The second door lock 7 is here a holding lock which serves to hold the sliding door 2 open in an open position of the sliding door 2. This is shown in dashed lines in FIG. 1a), too. The motor vehicle door lock arrangement 1 may also comprise a third door lock which is not shown in the figures. In various embodiments, the first door lock 6 may be located in a rear part of the sliding door 2. The second door lock 7 may be located in the front part of the sliding door 2. The third door lock, if applicable, may also be a primary lock which may be located in the front part of the sliding door 2. The door locks 6, 7 may comprise a detent mechanism with a catch and a pawl and the usual functionality.

The door locks 6, 7 can generally be latched and unlatched. In the latched state the door lock 6, 7 is usually in a holding engagement with a lock striker 8 shown only schematically in FIG. 1b). The catch may be held in the latched state by the pawl. If the door lock 6, 7 is unlatched usually the catch is turned into an unlatched state releasing the lock striker 8. In these cases, the lock striker 8 is part of a body of the motor vehicle 3. Therefore the door locks 6, 7 hold the sliding door 2 in a position relative to the body of the motor vehicle 3. Other types of door locks 6, 7 may also be used. In various embodiments, the door locks 6, 7 block any relative movement between the sliding door 2 and the body of the motor vehicle 3 when latched. However the door locks 6, 7, in particular the second door lock 7, may also be a braking lock excerting a braking force between the sliding door 2 and the body of the motor vehicle 3 but not completely blocking the movement.

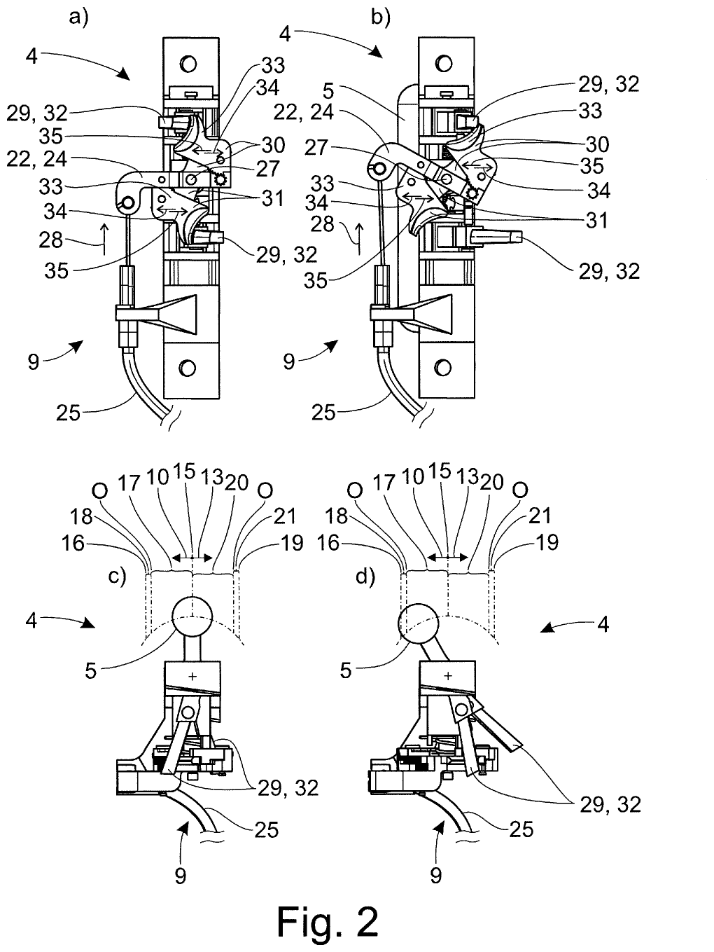

For unlatching the door locks 6, 7 the motor vehicle door lock arrangement 1 comprises a mechanical actuation drive train 9. The door handle 5 is connected to the first and the second door lock 6, 7 via the actuation drive train 9. The actuation drive train 9 comprises all mechanical elements that can interact to unlatch the door locks 6, 7 as will be described later on. The door handle 5 can be user-actuated by a first actuation in a first actuating direction 10. As can be seen in FIG. 1 the door handle 5 may be an inner door handle 11 or an outer door handle 12. As can be seen, here the outer door handle 12 is a door handle 5 of the pistol-type with a trigger element (not shown) which can be actuated only in a single actuating direction 10. The inner door handle 11, however, can be actuated in the first actuating direction 10 and in a second actuating direction 13. Various embodiments can useful for both types of door handles 5 as well as other types of door handles 5. As will be apparent later all descriptions made with reference to the first actuation and the first actuating direction 10 may be applied to the second actuation and to a second actuating direction 13 as well. A mechanism for an, in particular, inner, door handle 11 with two actuating directions 10, 13 will be described with reference to FIGS. 2 to 5. These descriptions should not be understood as limiting and may also be applied to other types of door handles 5.

The at least two door locks 6, 7 each comprise an actuation element 14 and can each be unlatched by the actuation of the door handle 5 in the first actuating direction 10, whereby the first actuation is mechanically transmitted through the actuation drive train 9 to each of the actuation elements 14. For example, a user pulling the inner door handle 11 into the first actuating direction 10 may thereby actuate all mechanical parts of the actuation drive train 9 and the actuation elements 14 therefore unlatching the door locks 6, 7. As will be described, not every part of every actuation is transmitted to the door locks 6, 7. Furthermore, the actuation drive train 9 will usually comprise a door lock logic for example a central locking arrangement enabling a user to lock the car such that an actuation of the door handles 5 will not lead to an unlatching of the door locks 6, 7. This door lock logic may also be part of the door locks 6, 7.

The first actuation comprises a first actuation stroke in the first actuating direction 10 from a neutral position 15 to a first end position 16 of the door handle 5. The actuation stroke can best be seen in FIGS. 2c) and d) and 3c) and d) respectively. The actuation stroke is usually made by the user when pulling the sliding door 2 into an opening or closing direction. The user will later release the door handle 5 from its end position 16, however, this release is usually done only after the sliding door 2 has reached its fully open or closed position. As described in the introductory portion of the description the door locks 6, 7 should not be in the unlatched state when the sliding door 2 reaches its fully open position or its fully closed position respectively.

It is therefore proposed that the first actuation stroke of the door handle 5 is divided into a first and a second stroke section 17, 18, the first stroke section 17 being followed by the second stroke section 18. During the first actuation stroke of the door handle 5 the actuation elements 14 of the door locks 6, 7 are actuated during the first stroke section 17 of the first actuation stroke and are not actuated during the second stroke section 18 of the first actuation stroke. This has the effect that while the user may be pulling the door handle 5 during a complete opening or closing of the sliding door 2 the door locks 6, 7 will be in the unlatched state only at the beginning of the respective opening or closing of the sliding door 2 and ready to engage the lock striker 8 afterwards. When the actuation elements 14 are not actuated the door locks 6, 7 do not necessarily have to be in the latched state. Especially while the sliding door 2 is moving they will rather be in an open state but ready to be closed by the engagement of the lock striker 8. This is a usual functionality of known door locks 6, 7.

While the first actuation stroke is shown in the figures with a partially round movement trajectory, any other movement trajectory is also possible.

As already mentioned the door handle 5 can also be user-actuated by a second actuation in a second actuating direction 13. This second actuating direction 13 can be opposite to the first actuating direction 10. In various embodiments, the second actuation is, apart from the different actuating direction, identical to the first actuation. Here there are at least two door locks 6, 7 which can each be unlatched by the second actuation of the door handle 5 in the second actuating direction 13, whereby the second actuation is mechanically transmitted through the actuation drive train 9 to each of the actuation elements 14. The second actuation comprises a second actuation stroke in the second actuating direction 13 from a neutral position 15, here the same neutral position 15 as for the first actuation, to a second end position 19 of the door handle 5. The second actuation stroke of the door handle 5 is also divided into a first and a second stroke section 20, 21, the first stroke section 20 being followed by the second stroke section 21. During the second actuation stroke of the door handle 5 the actuation elements 14 of the door lock 6, 7 are actuated during the first stroke section 20 of the second actuation stroke and are not actuated during the second stroke section 21 of the second actuation stroke.

The actuation drive train 9 can best be described with regard to FIG. 1b). Here the actuation drive train 9 comprises a coupling element 22. This coupling element 22 will be described with regard to the door handle module 4 in FIGS. 2 to 5, however, the coupling element 22 can also be part of any section of the actuation drive train 9, in particular, the yet to be described adapter module 23 or any of the door locks 6, 7.

In FIGS. 2 to 5, the coupling element 22 is shown as the main lever 24 which will also be described later on. The coupling element 22 respectively the main lever 24 is here connected by a Bowden cable 25 to the actuation element 14. The Bowden cable 25 is also part of the actuation drive train 9.

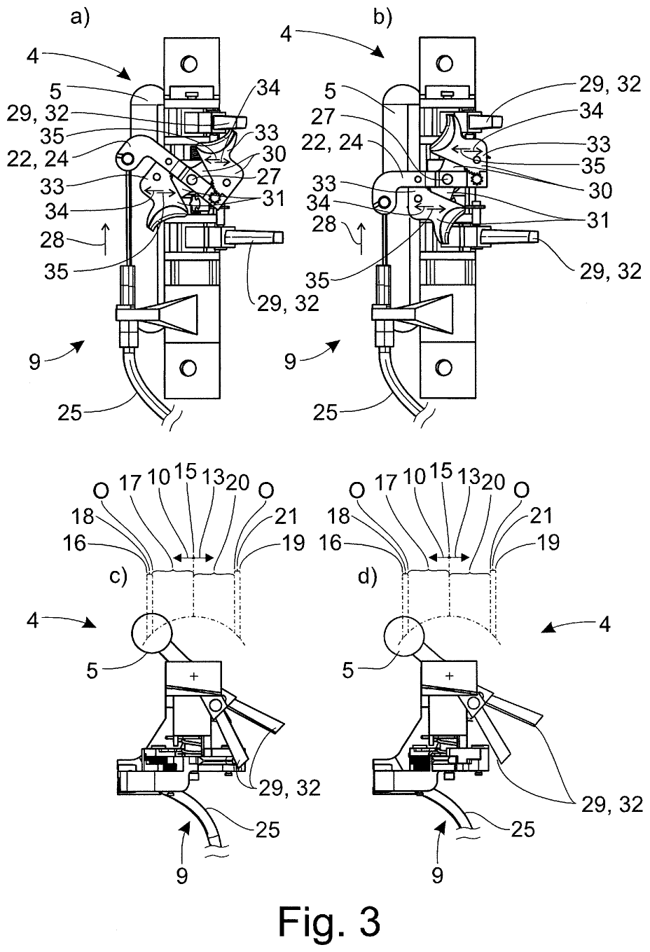

During the first stroke section 17, 20 of the first, and in some embodiments also the second, actuation stroke the coupling element 22 is deflected from the neutral position shown in FIGS. 2a) and c) thereby actuating the at least two door locks 6, 7. It may be the case during the second stroke section 18, 21, of the first, in some embodiments also the second, actuation stroke that the coupling element 22 is returned at least partially to the neutral position, shown in FIGS. 3b) and d), thereby not actuating the at least two door locks 6, 7 anymore.

Here a rear section of the actuation drive train 9 located between the at least two door locks 6, 7 and the coupling element 22 is coupled to the front section of the actuation drive train 9 located between the coupling element 22 and the door handle 5 during the first stroke section 17, 20 of the first, and in some embodiments also the second, actuation stroke. It is then intended that in the second stroke section 18, 21 of the first, and in some embodiments also the second, actuation stroke the front section is decoupled from the rear section. The coupling and the decoupling concerns the transmission of the actuation through the actuation drive train 9 which is only intended while the front section is coupled to the rear section.

The actuation drive train 9 may comprise a handle section 26 being part of the door handle module 4, wherein the handle section 26 comprises the main lever 24 with a pivot axis 27. As already mentioned the main lever 24 may be the coupling element 22.

Here it can be intended that during the first stroke section 17, 20 of the first actuation stroke the main lever 24 is pivoted around its axis 27 into an actuating direction 28 of the main lever 24 and during the second stroke section 18, 21 of the first actuation stroke the main lever 24 is pivoted around its axis 27 against the actuating direction 28 of the main lever 24.

The actuation stroke in the first actuating direction 10 can be seen by going through FIGS. 2a) and b) and 3a) and b) in that order. FIGS. 2a) and b) show the neutral position 15, FIGS. 2c) and d) show the handle 5 being actuated in the first actuating direction 10 still during the first stroke section 17, FIGS. 3a) and c) show the handle 5 reaching the end of the first stroke section 17 and FIGS. 3b) and d) show the door handle 5 reaching the end position 16 in the first actuating direction 10. As can be seen the coupling element 22, respectively the main lever 24, is actuated during FIG. 2b) and FIG. 3a) but not actuated anymore in FIG. 3b).

Here an actuation of the door handle 5 in the second actuating direction 13 will have the same effect on the coupling element 22, in particular, the main lever 24. Specifically it can be that during the first stroke section 20 of the second actuation stroke the main lever 24 is pivoted around its axis 27 in the actuating direction 28 of the main lever 24 and that during the second stroke section 21 of the second actuation stroke of the main lever 24 is pivoted around its axis 27 against the actuating direction 28 of the main lever 24.

As can also be seen from FIGS. 2 and 3, here, it is the case that during the first stroke section 17, 20 of the first, and in some embodiments also the second, actuation stroke the main lever 24 is pivoted from a neutral position (FIG. 2a)) to an end position (FIG. 3a)) and that during the second stroke section 18, 21 of the first, and in some embodiments also the second, actuation stroke the main lever 24 is returned from the end position to the neutral position (FIG. 3b)). Therefore while the door handle 5 is still actuated, the main lever 24 has returned to its neutral position thereby not actuating the actuation element 14 of the door locks 6, 7 anymore.

To enable providing a simple mechanism, it can be that the first and the second actuation of the door handle 5 are transmitted through the handle section 26 along different actuation paths, in some embodiments, that the different actuation paths both start at different parts of the main lever 24. Here the actuation of the door handle 5 is transmitted through pins 29. Here the main lever 24 has a first and a second lever arm 30 extending in opposite directions from the pivot axis 27. It may now be the case that the door handle 5 acts on the first lever arm 30 during the first actuation, in particular the first stroke section 17 of the first actuation stroke, and on the second lever arm 31 during the second actuation, in particular the first stroke section 20 of the second actuation stroke. In the figures the door handle 5 acts on the first lever arm 30 by one of the pins 29. This happens, here, only during the first stroke section 17, 20 of the first and/or second actuation stroke.

Regarding the first stroke sections 17, 20 on the one hand and the second stroke sections 18, 21 on the other hand it can be that they are non-overlapping.

For interaction with the coupling element 22 the actuation drive train 9 may comprise an engaging element 32 that directly engages the coupling element 22 during the first stroke section 17, 20 of the first actuation stroke and/or the second actuation stroke. Here the engaging element 32 is one of the pins 29 shown in FIGS. 2 to 5. As can be seen, here the actuation drive train 9 comprises two engaging elements 32, here both pins 29, each being associated with one actuating direction 10, 13.

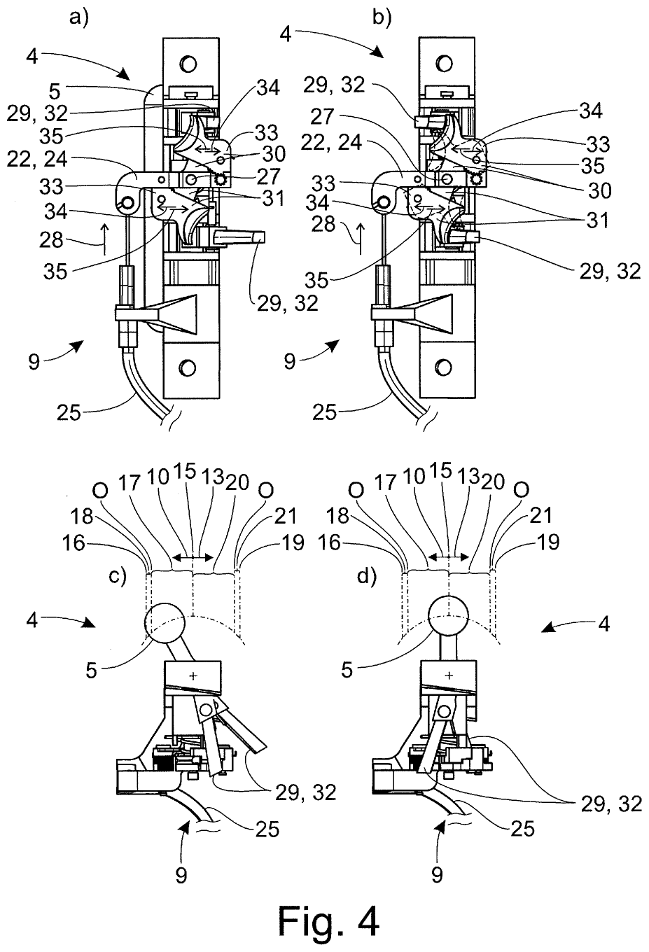

Here the engaging element 32 moves from a neutral position 15 (FIGS. 2a) and c)) to an overtravel position O (FIGS. 3a) and c)) during the first stroke section 17, 20 of the first actuation stroke and/or the second actuation stroke. During the second stroke section 18, 21 of the first actuation stroke and/or the second actuation stroke the engaging element 32 passes by the coupling element 22, disengaging the coupling element 22, as can be seen in the transition from FIG. 3a) to FIG. 3b). As can be seen in FIG. 4, here the engaging element 32 engages and/or passes by the coupling element 22 during or the release of the door handle 5 from the first and/or second actuation without actuating the at least two door looks 6, 7, returning through the overtravel position O (FIG. 4a)) to the neutral position 15 (FIG. 4b)). Here the neutral position 15, the overtravel positions O and the end positions 16, 19 of the door handle 5 and the engaging element 32 correspond to each other.

The main lever 24 may comprise one secondary lever 33, in some embodiments one secondary lever 33 on each main lever arm 30, 31, mounted pivotally on the main lever 24. It can be that during the first and/or second actuating stroke, in particular, during the first stroke section 17, 20 of the first and/or second actuation stroke, the secondary lever 33 is deflected in a first direction 34 of the secondary lever 33 and deflects the main lever 24 and then during the second stroke section 18, 21 of the first and/or second actuation stroke the secondary lever 33 is deflected in a direction 35 opposite to the first direction 34 of the secondary lever 33 without deflecting the main lever 24. As can be seen in the figures the first direction 34 and the opposite direction 35 of the secondary levers 33 can differ for the respective secondary levers 33 in the respective actuating directions of the handle 5. The deflecting in the opposite direction 35 of the secondary lever 33 during the second stroke section 18, 21 can be just a return into a neutral position of the secondary lever 33.

As has been mentioned the door handle 5 may be connected, in particular directly, to a first and a second pin 29 which pins 29 each constitute an engaging element 22, each pin 29 engaging an associated secondary lever 33 during the first stroke section 17, 20 of the respective actuation stroke in the first direction 34 of the secondary lever 33 and in some embodiments disengaging the secondary lever 33 during the second stroke section 18, 21 of the actuation stroke.

Here the pin 29, in particular, both pins 29, engage the associated secondary lever 33 during a release of the door handle 5 in the direction 35 opposite to the first direction 34 of the secondary lever 33. Here the secondary lever 33 pivots from its neutral position into the direction 35 opposite to the first direction 34 of the secondary lever 33 until the respective pin 29 passes by the secondary lever 33 returning to its neutral position (shown in dashed lines in FIG. 4b)). This actuation of the secondary lever 33 during the release of the door handle 5 is not intended to actuate the main lever 24. For that reason the secondary lever 33, in particular, both secondary levers 33, is, here, able to run free in the direction 35 opposite to the first direction 34 of the secondary lever 33.

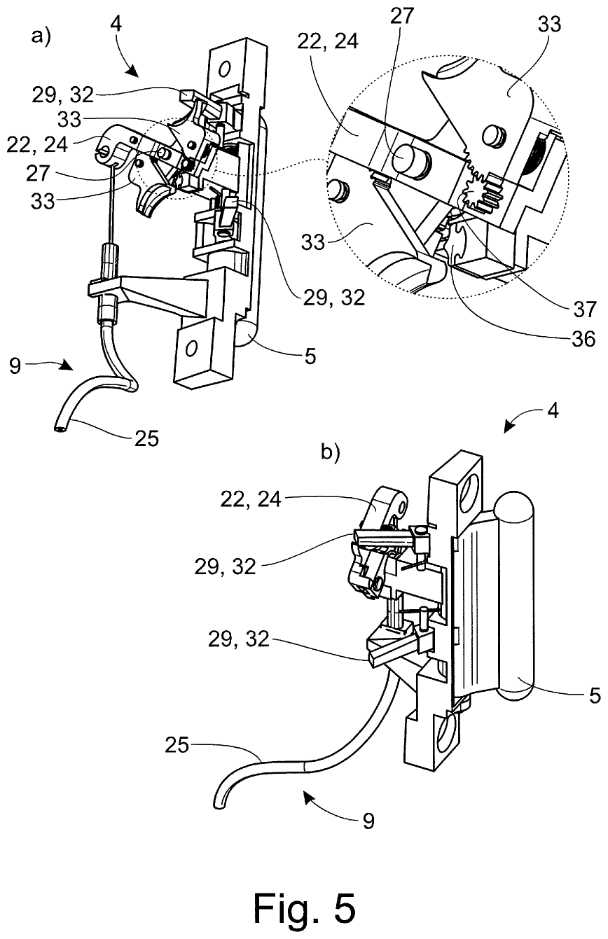

While the mechanical structure of various embodiments of the door handle module 4 can be very simple, it may produce unwanted noise during actuation and/or release of the door handle 5. Therefore it can be that the coupling element 22 in general, in particular the main lever 24, is dampened at least partially in movement during deflection from the neutral position and/or during returning to the neutral position. Here the coupling element 22 engages a primary dampening element 36 when reaching its neutral position and/or the end position. Here the pivoting of the secondary lever 33 or levers 33 is dampened by a secondary dampening element 37. Both dampening elements 36, 37 can be seen best in FIG. 5.

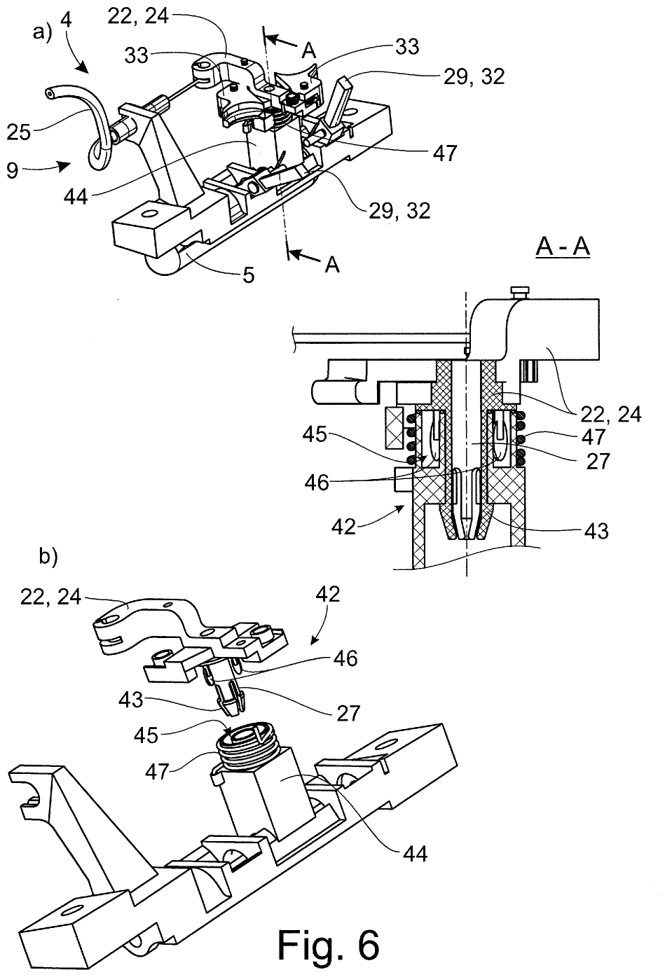

Additionally or alternatively, the coupling element 22 is dampened by a hydraulic and/or pneumatic dampening element 42, as generally shown in FIG. 6. The hydraulic and/or pneumatic dampening element 42 may in particular dampen the rotational movement of the coupling element 22. In some embodiments, the hydraulic and/or pneumatic dampening element 42 is arranged on the pivot axis 27 of the main lever 24. The pivot axis 27 may comprise a snap-in connection 43 to a base element 44 for the main lever 24. The hydraulic and/or pneumatic dampening element 42 may comprise a chamber 45 to accommodate a dampening gas and/or dampening fluid, here an oil with a given viscosity, which can be seen in the sectional view of FIG. 6a). Further, resistance elements 46 are arranged in the chamber 45. When the main lever 24 is rotated, a relative motion between the oil in chamber 45 and the resistance elements 46 is created, providing an additional dampening effect. In some embodiments, the main lever 24 is pretensioned against the base element 44 by means of a spring element 47.

Returning from the specific door handle module 4 to the general actuation drive train 9 as shown in FIG. 1b), it is here the case that the actuation drive train 9 comprises a first connecting section 38 where the actuation drive train 9 consists of a single connecting element 39, in particular a Bowden cable 25. It should be noted that the actuation drive train 9 is defined relative to a single door handle 5 such that FIG. 1b) shows two actuation drive trains 9 with two single connecting elements 39, one for each door handle 5.

Here the first and the second actuation are transmitted in the same direction through the connecting element 39 of the first connecting section 38. In particular, the first and the second actuation are transmitted identically through the connecting element 39 of the first connecting section 38. It is furthermore that the connecting element 39 can be connected directly to the coupling element 22, in particular, the main lever 24, or the engaging element 32. This clarifies again that the coupling element 22 and the engaging element 32 do not have to be part of the door handle module 4 but could also be part for example of the adapter module 23.

Here the actuation drive train 9 comprises a second connecting section 40 where the actuation drive train 9 is split into at least two connecting elements 41, in particular, Bowden cables, by an adapter module 23 of the second connecting section 40 of the actuation drive train 9. As can be seen in FIG. 1b) the second connecting section 40 may be used for more than one door handle 5. Here each of the connecting elements 41 of the second connecting section 40 is directly connected to an actuation element 14.

In general it can be that the door handle module 4 comprises an inner door handle 11 and an outer door handle 12, that the inner door handle 11 can be actuated in a first and a second actuating direction 10, 13 and the outer door handle 12 can be actuated only in a first actuating direction 10. It can however just as advantageously be intended that the outer door handle 12 can be actuated in a first and a second actuating direction 10, 13 and the inner door handle 11 can be actuated only in a first actuating direction 10. It could also be the case that both door handles 11, 12 can be actuated only in a first actuating direction 10 or in a first and a second actuating direction 10,13.

Both door handles 11, 12 may be connected to the adapter module 23, such as by separate actuation drive trains 9. The coupling element 22 may then be part of the adapter module 23 whereby each actuation can be conducted through the coupling element 22 in the same manner. It is clear that then the second connecting section 40 for both door handles 10, 11 is the same. This way only a single coupling element 22 can be used for multiple door locks 6, 7 and multiple door handles 11, 12.

According to a second teaching the door handle module 4 for a sliding door 2 is provided. The door handle module 4 comprises a door handle 5 and the door handle module 4 also comprises the coupling element 22. The door handle 5 can be user-actuated by a first actuation in a first actuating direction 10 and the door handle module 4 may be connectable to at least two door locks 6, 7 such that an actuation element 14 of each of the two door locks 6, 7 can be unlatched by the actuation of the door handle 5 in the first actuating direction 10. The door handle module 4 may comprise part of a mechanical actuation drive train 9 and may be connectable to a part of a mechanical drive train 9 which is connected to each of the actuation elements 14. This actuation drive train 9 is supposed to transmit the first actuation mechanically. The first actuation comprises a first actuation stroke in the first actuating direction 10 from a neutral position 15 to a first end position 16 of the door handle 5. The first actuation stroke of the door handle 5 divided into a first and a second stroke section 17, 18, the first stroke section 17 being followed by the second stroke section 18. During the first actuation stroke of the door handle 5 the actuation elements 14 of the door locks 6, 7 may be actuated during the first stroke action 17 of the first actuation stroke and may not be actuated during the second stroke section 18 of the first actuation stroke.

The door handle module 4 can be mounted on the sliding door 2 such that the first actuating direction 10 is, at least mostly, direct towards an opening direction of the sliding door 2 and the second actuating direction 13 is, at least mostly, directed towards a closing direction of the sliding door 2. Here the first door lock 6 is a front lock and the second door lock 7 is a rear lock.

1. A motor vehicle door lock arrangement for a sliding door of a motor vehicle, comprising a door handle module with a door handle, at least a first door lock, a second door lock, and a mechanical actuation drive train,
wherein the door handle is connected to the first and the second door lock via the actuation drive train,
wherein the door handle can be user-actuated by a first actuation in a first actuating direction
wherein the at least two door locks each comprise an actuation element and can each be unlatched by the actuation of the door handle in the first actuating direction, whereby the first actuation is mechanically transmitted through the actuation drive train to each of the actuation elements,
wherein the first actuation comprises a first actuation stroke in the first actuating direction from a neutral position to a first end position of the door handle,
wherein the first actuation stroke of the door handle is divided into a first and a second stroke section, the first stroke section being followed by the second stroke section, and
that during the first actuation stroke of the door handle the actuation elements of the door locks are actuated during the first stroke section of the first actuation stroke and are not actuated during the second stroke section of the first actuation stroke.

2. The motor vehicle door lock arrangement according to claim 1, wherein the door handle can be user-actuated by a second actuation in a second actuating direction, which is opposite to the first actuating direction,
that the at least two door locks can each be unlatched by the second actuation of the door handle in the second actuating direction, whereby the second actuation is mechanically transmitted through the actuation drive train to each of the actuation elements,
wherein the second actuation comprises a second actuation stroke in the second actuating direction from a neutral position to a second end position of the door handle,
that the second actuation stroke of the door handle is divided into a first and a second stroke section, the first stroke section being followed by the second stroke section, and
wherein during the second actuation stroke of the door handle the actuation elements of the door locks are actuated during the first stroke section of the second actuation stroke and are not actuated during the second stroke section of the second actuation stroke.

3. The motor vehicle door lock arrangement according to claim 1, wherein the actuation drive train comprises a coupling element, that during the first stroke section of the first actuation stroke the coupling element is deflected from a neutral position thereby actuating the at least two door locks, and that during the second stroke section of the first actuation stroke the coupling element is returned at least partially to the neutral position thereby not actuating the at least two door locks anymore.

4. The motor vehicle door lock arrangement according to claim 1, wherein the actuation drive train comprises a handle section being part of the door handle module, that the handle section comprises a main lever with a pivot axis,
wherein during the first stroke section of the first actuation stroke the main lever is pivoted around its axis into an actuating direction of the main lever and that during the second stroke section of the first actuation stroke the main lever is pivoted around its axis against the actuating direction.

5. The motor vehicle door lock arrangement according to claim 4, wherein during the first stroke section of the first actuation stroke the main lever is pivoted from a neutral position to an end position and that during the second stroke section of the first actuation stroke the main lever is returned from the end position to the neutral position.

6. The motor vehicle door lock arrangement according to claim 2, wherein the first and the second actuation of the door handle are transmitted through the handle section along different actuation paths.

7. The motor vehicle door lock arrangement according to claim 3, wherein the actuation drive train comprises an engaging element that directly engages the coupling element during the first stroke section of the first actuation stroke and/or the second actuation stroke, that the engaging element moves from a neutral position to an overtravel position during the first stroke section of the first actuation stroke and/or the second actuation stroke and that the engaging element passes by the coupling element, disengaging the coupling element during the second stroke section of the first actuation stroke and/or the second actuation stroke.

8. The motor vehicle door lock arrangement according to claim 4, wherein the main lever comprises at least one secondary lever, mounted pivotally on the main lever,
wherein during the first and/or second actuation stroke, the secondary lever is deflected in a first direction of the secondary lever and deflects the main lever and that during the second stroke section of the first and/or second actuation stroke the secondary lever is deflected in a direction opposite to the first direction of the secondary lever without deflecting the main lever.

9. The motor vehicle door lock arrangement according to claim 8, wherein the door handle is connected to a first and a second pin which pins each constitute an engaging element, each pin engaging an associated secondary lever during the first stroke section of the respective actuation stroke in the first direction of the secondary lever and preferably disengaging the secondary lever during the second stroke section of the respective actuation stroke.

10. The motor vehicle door lock arrangement according to claim 3, wherein the coupling element is dampened at least partially in movement during deflection from the neutral position and/or during returning to the neutral position, wherein the coupling element engages a primary dampening element when reaching its neutral position and/or an end position of the coupling element.

11. The motor vehicle door lock arrangement according to claim 10, wherein the coupling element is dampened by a hydraulic and/or pneumatic dampening element, wherein the hydraulic and/or pneumatic dampening element is arranged on the pivot axis of the main lever.

12. The motor vehicle door lock arrangement according to claim 1, wherein the actuation drive train comprises a first connecting section where the actuation drive train consists of a single connecting element.

13. The motor vehicle door lock arrangement according to claim 1, wherein the actuation drive train comprises a second connecting section where the actuation drive train is split into at least two connecting elements by an adapter module of the second connection section of the actuation drive train.

14. The motor vehicle door lock arrangement according to claim 1, wherein the door handle module comprises an inner door handle and an outer door handle, that the inner door handle can be actuated in a first and a second actuating direction and the outer door handle can be actuated only in a first actuating direction.

15. A door handle module for a sliding door according to claim 3, wherein the door handle module comprises a door handle and that the door handle module comprises the coupling element.

16. The door handle module according to claim 15, wherein the door handle module can be mounted on the sliding door such that the first actuating direction is, at least mostly, directed towards an opening direction of the sliding door and that the second actuating direction is, at least mostly, directed towards a closing direction of the sliding door.

17. The motor vehicle door lock arrangement according to claim 3, wherein during the first stroke section of the first actuation stroke a rear section of the actuation drive train located between the at least two door locks and the coupling element is coupled to a front section of the actuation drive train located between the coupling element and the door handle and wherein the second stroke section of the first actuation stroke the front section is decoupled from the rear section.

18. The motor vehicle door lock arrangement according to claim 4, wherein during the first stroke section of the second actuation stroke the main lever is pivoted around its axis into the actuating direction of the main lever and that during the second stroke section of the second actuation stroke the main lever is pivoted around its axis against the actuating direction of the main lever.

19. The motor vehicle door lock arrangement according to claim 6, wherein the different actuation paths both start at different parts of the main lever,

20. The motor vehicle door lock arrangement according to claim 19, wherein the main lever has a first and a second lever arm extending in opposite directions from the pivot axis and that the door handle acts on the first lever arm during the first actuation, in particular the first stroke section of the first actuation stroke, and on the second lever arm during the second actuation, in particular the first stroke section of the second actuation stroke.
